(19) United States
(12) Patent Application Publication
(10) Pub. No.: US 2018/0018943 A1
(43) Pub. Date: Jan. 18, 2018

(54) DUAL DISPLAY IMMERSIVE SCREEN TECHNOLOGY

(71) Applicant: THE TECHNOLOGY PARTNERSHIP PLC, Royston, Hertfordshire (GB)

(72) Inventors: Roger CLARKE, Royston (GB); Andrew KADIS, Royston (GB)

(73) Assignee: The Technology Partnership Plc, Royston, Hertfordshire (GB)

(21) Appl. No.: 15/544,748

(22) PCT Filed: Jan. 19, 2016
(86) PCT No.: PCT/GB2016/050110

§ 371 Date: Jul. 19, 2017

(30) Foreign Application Priority Data
Jan. 20, 2015 (GB) 1500891.5

(51) Int. Cl. G09G 5/14; G06F 3/01

(52) U.S. Cl. CPC G09G 5/14; G09G 2340/0407; G06F 3/012; G06F 3/013

(57) ABSTRACT

An optical system comprises a transparent display arranged to be placed in the near field view of a user. Image generation means generates an image on the transparent display, the formed image having a blank area formed therein to allow a viewer to view an image of higher resolution than the first.

The present invention relates to the combination of a high resolution display, or scene, typically in the centre of the field of view of the user, and an additional display device placed much closer to the user to provide a relatively low resolution and typically out-of-focus peripheral display to give the user a feeling of total environmental immersion. Preferably, the peripheral display should also be transparent or partially transparent, and eye and head tracking should be used to fuse the high resolution and peripheral displays in real time so that the user experiences one very wide angle scene. This combination of displays converts pre-existing widely available high resolution displays such as TV's, computer monitors, laptop screens and mobile phone screens into very wide angle immersive environments at very low cost using the addition of the low resolution display which may be incorporated into a head worn portable device.

Many virtual reality optical systems have been devised to give the user a feeling of being immersed in an environment. One typical implementation is to use optically opaque head mounted displays that obscure the outside world but display a virtual world to the user via a display screen inside the head mount. The display typically includes a LCD or OLED screen and some relay optics to present the image to the user at a comfortable viewing distance. The field of view of these systems is typically limited by the relay optics. Very wide angular displays also require very high numbers of pixels in the display to provide a reasonable number of pixels per angle of view, assuming a uniform number of pixels per degree of view. Since the number of pixels in a typical HD display is 1920×1080, if this display was to be used over a 180° horizontal viewing angle then the pixels per degree would be 10.7 along the horizontal axis. 20/20 vision is equivalent to 2 arcminutes per line pair, or 0.033 degrees per line pair. Therefore the HD display over 180° would be approximately 320 times less detailed than the eye can perceive, and hence would be a very poor display.

Another typical implementation is to create a room with images projected onto the walls to surround the viewers inside. This requires a dedicated room and a great deal of complex and expensive infrastructure to achieve the feeling of immersion. It is therefore not suitable for home use.

According to the present invention, there is provided a high resolution display or scene for the central field of view and an additional lower resolution display for the peripheral vision. For the purposes of clarity hereon we refer to a high resolution display, such as a TV, computer screen or mobile phone screen. Preferably, for a head mounted implementation the low resolution display should be arranged close to the face, and be transparent and clear.

Ideally, it would be desirable to have a high definition display that covers the full field of view. However, what the applicants have appreciated is that it is generally necessary only to have the central area to be of high definition so that the eye can look at detail over the most commonly viewed angles. If the eye has to move more than about 15° then the head generally rotates to move the object of attention to the centre of the field of view. Therefore the typically used field of view is more like 30°. Only approximately 70° of the view is binocular. The full field of view and awareness is typically 190°. The widest 60° at each side is of very low resolution, but important for awareness and the sense of being imbedded in the environment. Colour and movement are sensed in this area. Since the resolution of the eye drops rapidly outside of the foveal field of view (approx 2°), the display resolution need not be very high outside of the fovea. More generally, if the display resolution outside of the typical 30° is low resolution then it will not generally be noticed unless the eye deliberately looks outside of this typical viewing angle. Therefore if a display is created with high resolution in the central field of view and low resolution outside of this are extending fully out to 190° then the user experiences a fully immersive environment.

The low resolution display should have a ‘blank area’ in the regions of the low resolution transparent display corresponding to the view high resolution display. In this way the view of the high resolution is not disturbed. For this reason the low resolution display may be preferred to be transparent so that the head can change viewing angle and the ‘blank area’ region can be moved accordingly. The low resolution display should show a lower resolution display outside of this blank area that substantially matches the scene of the high resolution display. Therefore the viewer should see an entire scene of up to 190° field of view, with a high definition central region and a matched lower resolution peripheral region, which is typically out of focus. Preferably, the low resolution display should dynamically track the position and angle of the high resolution display as viewed by each eye and display the corresponding matching image to each eye.

Examples of the present invention will now be described with reference to the accompanying drawings, in which:

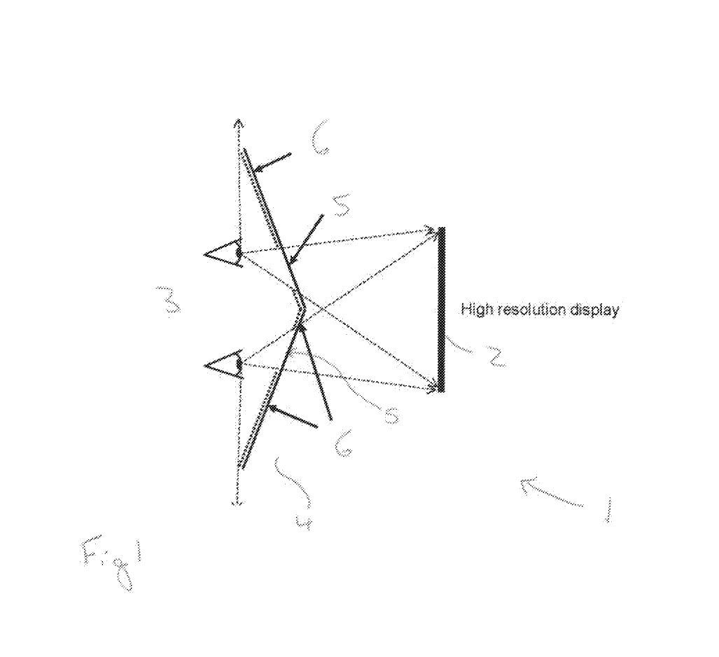

FIG. 1 is a plan schematic view of an example of the present invention;

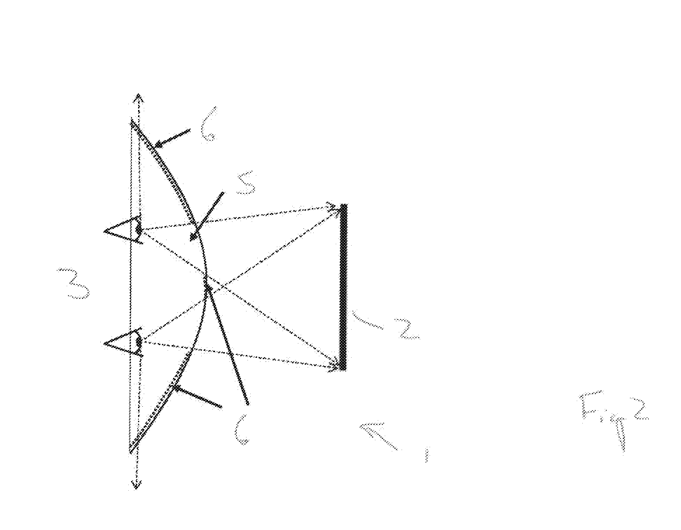

FIG. 2 is a schematic plan view of a second example of the present invention employing a curve display;

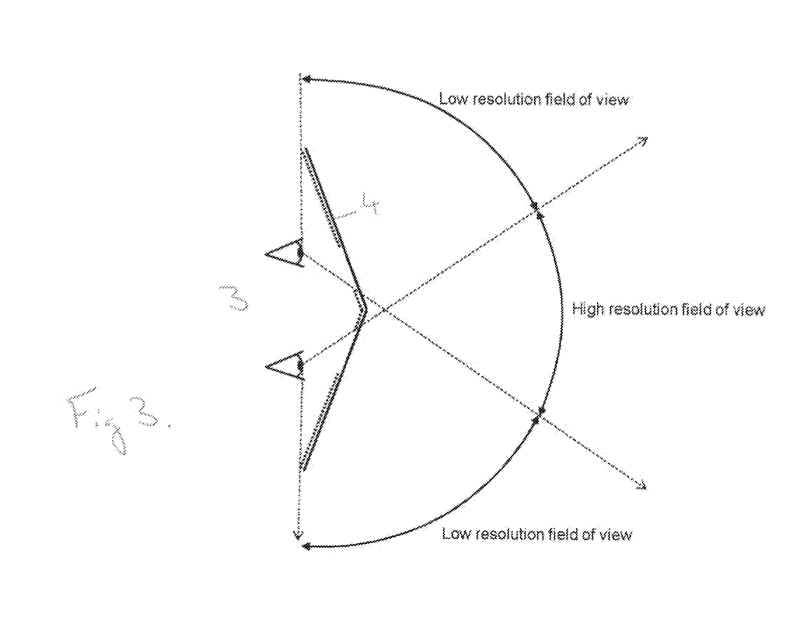

FIG. 3 is a schematic plan view showing the fields of view and resolution levels of different components of a display according to the present invention;

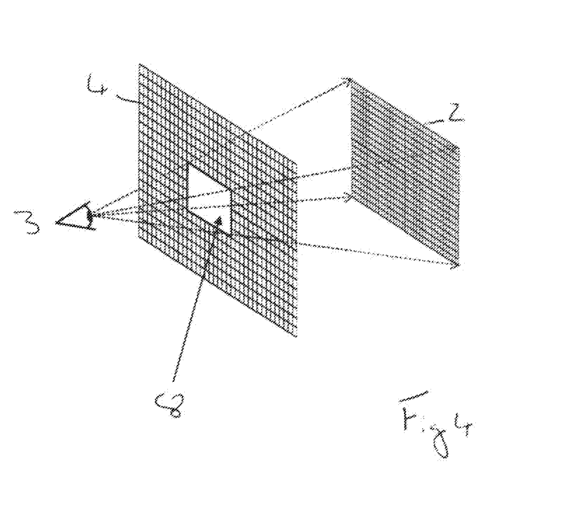

FIG. 4 shows a system of the present invention in schematic form with a monocular view;

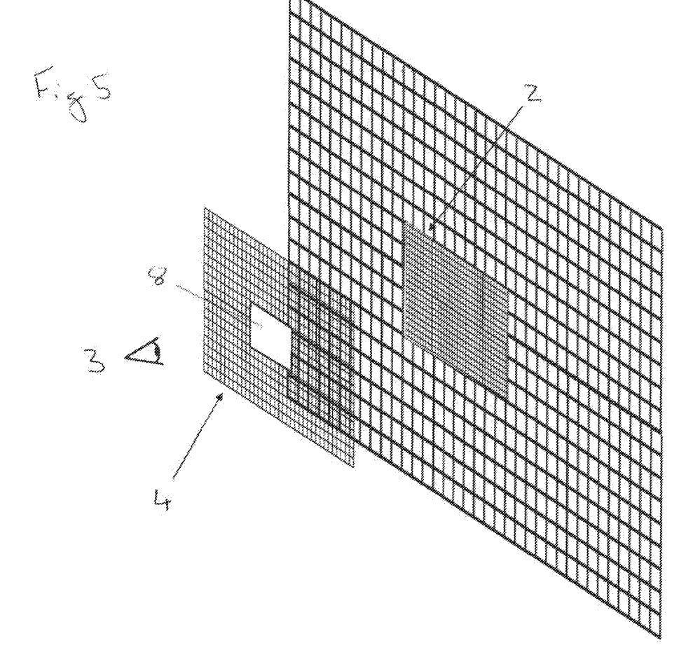

FIG. 5 shows a further example of the invention with a monocular view;

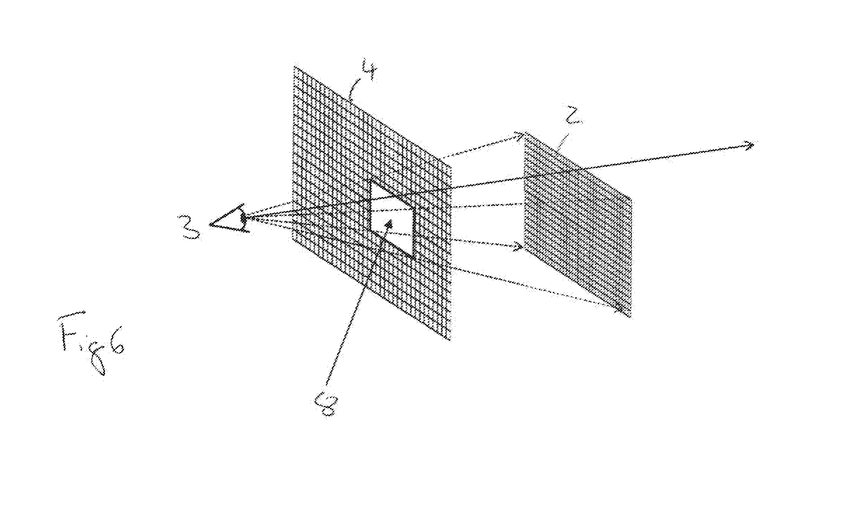

FIG. 6 shows a further monocular example of the present invention with horizontally shifted blank region;

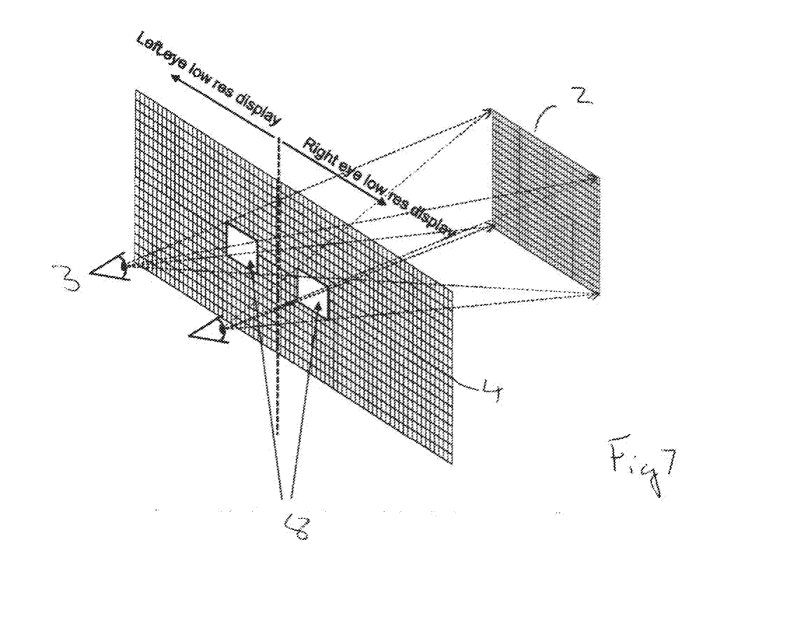

FIG. 7 is a schematic view of a binocular arrangement in accordance with the present invention;

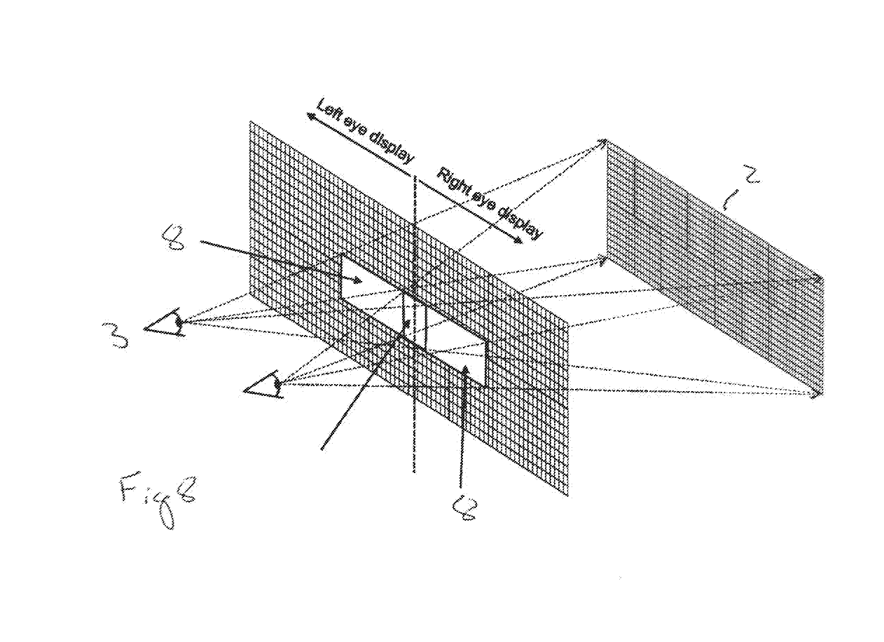

FIG. 8 is a schematic view of a further example of a binocular arrangement according to the invention with merged blank areas;

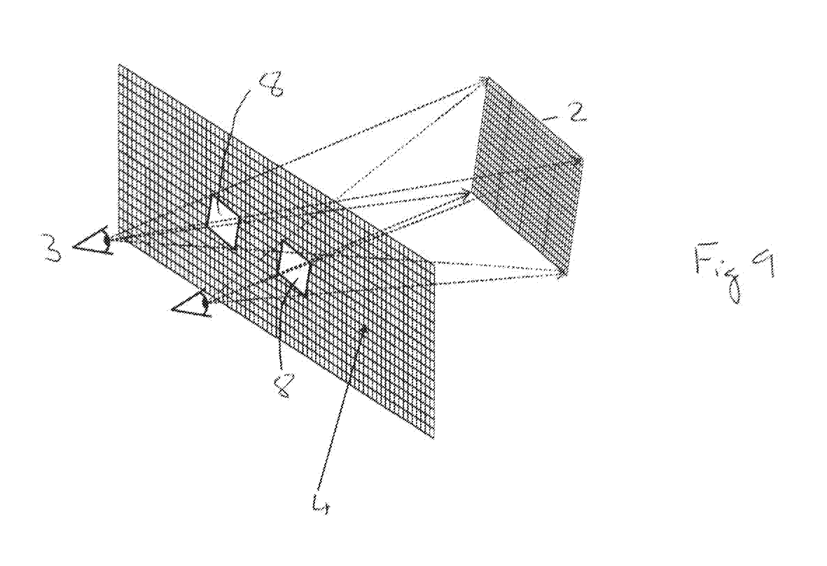

FIG. 9 is a further schematic view of a binocular configuration according to the invention with rotated high resolution screen;

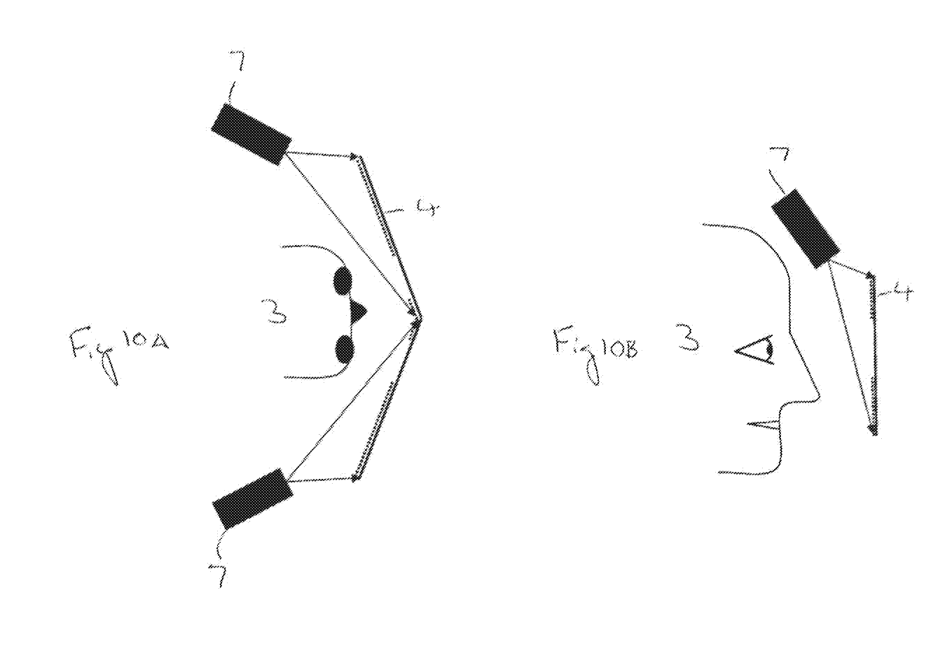

FIGS. 10A and 10B are schematic diagrams showing the position of projectors employed in the present invention;

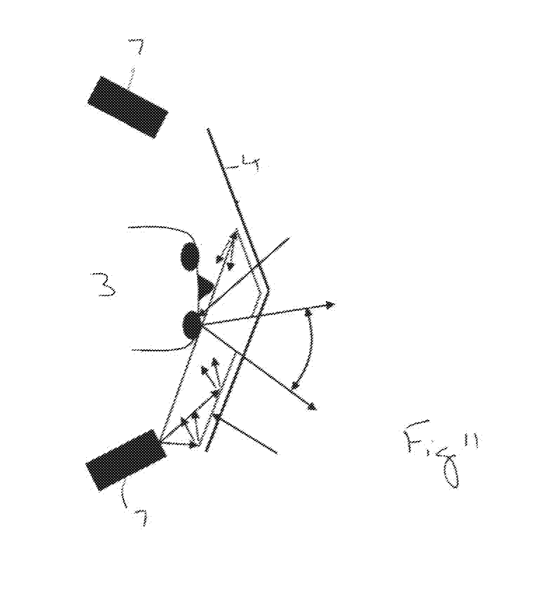

FIG. 11 shows a yet further example of the present invention employing an angled diffuser; and

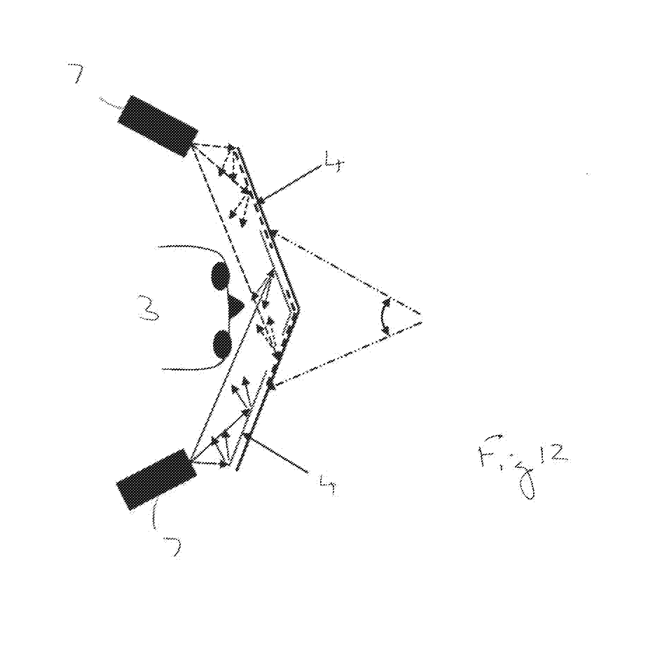

FIG. 12 is a schematic view of a further example of the invention employing an angle diffuser.

Referring to FIG. 1, a display according to the present invention has a high resolution display component 2 positioned some distance from a user 3. The user 3 has a head mounted display 4 comprising one or more transparent “blank” regions 5 and one or more low resolution display areas 6. In FIG. 1 the transparent display is formed of two flat transparent panels, but as shown in FIG. 2, it can be formed from a single curved panel. In FIG. 2 components that correspond to those in FIG. 1 are numbered identically.

In the present invention, the low resolution transparent display 6 (hereafter to be called the transparent display) should be placed close to the user's eyes e.g. within 20 cm, so that the head mounted display 4 is not too big. Since the user will typically be looking at the high resolution display at a distance from approximately 40 cm to infinity the transparent display will be out of focus. This is not a major concern since this display is designed to be viewed as low resolution and in the peripheral vision in the first place. Therefore the transparent display 6 could be positioned, for example, approximately 5 cm from each eye and give the immersive effect. The ability to put the transparent display 6 close to each eye without significantly compromising the immersive experience is a key advantage of this invention, since it keeps the size of the head mounted display 4 relatively small, whilst providing for high resolution central viewing.

The image displayed on the transparent display must appropriately blend the central high resolution display with the relatively low resolution transparent display. To do this the transparent display should display the correct image to the user, with the angular size, shape and position of the blank viewing area 6 corrected so that it matches the angular size, shape and position of the high resolution display. Sensors such as cameras and eye trackers can be used to determine the relative spatial and angular positions of the head, eyes, transparent display 6 and high resolution display 2. With this information the transparent display can display the correct images, both in terms of the size, shape and position of the blank area and the images to be displayed outside of this area.

FIG. 3 shows the field of view of a device 1 according to the present invention together with an indication of the areas which would generally be considered to be low resolution fields of view and a central high resolution field of view.

The transparent display can be flat, as shown in FIG. 1, or curved, as shown in FIG. 2, but is preferably curved to fit a general face shape and give a wide field of view without the display being too large. There are several technologies that could be used to for the transparent display, however they must be substantially clear so that the user can look at the high resolution display 2 through the transparent display 5 at substantially any angle. Possible examples are transparent OLED or similar displays.

One particularly suitable technology is described in GB1304114.0 which uses and diffusing structure with a coating on it which is embedded in between two media of substantially the same refractive index. This means that the transmitted light is angularly undeviated so it shows no haze in transmission. Light that this reflected from the diffusing structure is diffused over a range of angles determined by the diffusing properties of the structure. This structure therefore acts as a diffusing screen in reflection and is capable of acting as a reflective display screen if an image is projected onto the structure. This device is particularly useful in this present invention because it has no haze in transmission and acts as a display screen in reflection. It can also be easily produced in a curved format using low cost processes. Therefore one or more projectors can be used to form the image on the transparent screen, whilst the user can still see the high resolution screen in transmission. It will be appreciated that to maintain reasonable focus of the projector image onto the transparent display several image transformations will need to be used in either hardware, software or both, such as keystoning and other image distortions, focus adjustment and intensity adjustment. It will also be appreciated that since the transparent display image will be viewed as out of focus by the user, the image formed on the transparent display need not be as highly focussed as is usually required, and therefore these focus requirements are relatively lower than would otherwise be the case.

Another advantage of this transparent display technology is that if the diffuser is designed appropriately then the light from a projector can be reflected into an eye of choice, such that if there are two projectors then each eye can only receive light from one projector.

Examples of this configuration can be seen in FIGS. 11 and 12. In FIG. 11 only the right projector is shown projecting an image for ease of understanding, and in FIG. 12 both the right and left projectors are shown projecting. In both Figures the continuous dots show image light from the right projector, and in FIG. 12 the continuous dashes show image light from the left projector. (this section was previously in the middle of the diffuser and grating section, which is incorrect since this is to do with angular response of the diffuser to provide stereoscopic information only).

The advantages of this implementation become greater as the transparent display is placed further from the user's eye, as the peripheral vision around the blank windows at the sides corresponding to centre of the field view becomes smaller, until the blank window area for each corresponding eye become overlapped. If the directionality of the diffuser is chosen correctly then the transparent display could show the image for the right eye from the far right of the field of view to full left of the field of view visible by the eye. This means that the transparent display images would be observed binocularly and if the images were constructed as stereoscopic images then the user would perceive the images as being in a 3D environment, albeit out of focus. This would be particularly applicable for moving objects, where the perception of depth is given by time evolving stereoscopic information rather than focus information.

FIG. 4 shows a monocular view of a device according to the present invention with a high resolution display 4 with a blank 8 positioned in the middle of it for viewing the high resolution display 2 from a user's position 3. FIG. 5 shows a similar configuration with a blank 8 in the low resolution transparent display 4 but here the high resolution display 2 is surrounded by a perceived low resolution display that can be used to generate images of lower resolution and which is slightly out of focus to improve the viewing experience. FIG. 6 shows a similar example where the blank 8 and high resolution display 2 are offset from the centre of the field of view. Here the blank area has moves to accommodate a change in the position of the high definition display with respect to the viewer. This can be achieved by control of the generation of the image based upon the output of sensors determining the viewer's position with respect to the high definition image.

FIG. 7 shows a further example of the invention with a binocular view two blanks 8 in the low resolution display 4 so that the high resolution display 2 can be viewed via the eye of a user aligned with the respective blank. FIG. 8 shows a variation of the configuration of FIG. 7 in which the high resolution display is extended in the horizontal direction to allow an immerse viewing experience. In the case illustrated the blank areas for each eye merge. FIG. 9 shows a yet further example in which the blanks 8 and high resolution display 2 are rotated in the plane of the low resolution display 4 and high resolution display 2 respectively. This scenario occurs if the head is tilted with respect to the high resolution display, Again this can be achieved by control of the generation of the image based upon the output of sensors determining the viewer's position with respect to the high definition image.

A convenient light source is a laser projector since they are typically very compact and the optics typically give an image that is in focus from a few cm to infinity, therefore enabling easy projection onto curved surfaces at high angles. An example of a laser projector is the Microvision SHOWWX laser projector, which claims a 15 lumens output. To demonstrate that it is an acceptable power output we will assume that two projectors are required, one for each eye, and that the area projected onto is 100×100 mm. It will be appreciated that the area required is increased or decreased as the transparent display is moved further or closer to the user respectively. The estimated area is 100×100 mm=0.01 m̂2. The unit of luminance (nits) is defined as lumens/area/Steradian. For our example the luminance is 15/(0.01*Pi)=480 nits, assuming a Lambertian reflector. We now assume that the transparent display uses the embedded diffuser technology with a 75% transmittance (greater than a car window), and a reflectance of 25%. Therefore the user will see an apparent brightness of 480×0.25=120 nits. For comparison, the average brightness of an office LCD display varies from 50 to 300 nits. Since the transparent display transmits 75% in this example the brightness observed will be approximate 38 to 225 nits for the same LCD displays. Therefore, for typical screen brightness this laser projector has enough power to provide for an equivalently bright display in the transparent display region. It will be appreciated that the size of transparent display can be reduced, the laser power can be increased, and the reflectivity of the transparent display can also be increased to increase the luminance further if required.

FIGS. 10a and 10b show the possible positions for projector 7 that can be employed with the display system 1 of the present invention. In FIG. 10a there are two projectors, one for each eye, each positioned at one side of the head. In FIG. 10b two projectors are provided, again one for each eye, but in this case the projectors are located above the eyes. It will be appreciated that the projectors could be positioned elsewhere, for example below the user's eyes, but that there are particular advantages to the configurations that are shown in the Figure.

The two displays need to be matched from the users point of view. This requires accurate positioning of the ‘blank window’ area in the transparent display to view the high resolution display through. To reduce the required accuracy of the alignment process it may be useful to provide for a small amount of image blurring at the edge of the high resolution display, so there is a feathering effect from one display to the other. There may also be a deliberate overlap of images within or close to this region and a corresponding feathering of brightness from one display to the other. These and other techniques may be used to produce a smoother transition from the high resolution display to the transparent display.

If the system is to work as a head mounted display system then sensors will be needed to detect the angle, size and position the high resolution display(s) or people/objects, head mounted transparent display with respect to the users eyes, and eye tracking sensors to detect the gaze angle of the eyes. Since rotation of the eyes also causes a displacement in the pupil the eye rotation angle is needed to calculate the position of the blank area in the transparent display. This becomes more important when the transparent display becomes closer to the eye, since the eye movement shift is significant compared to the blank area dimensions, and significant parallel error could result. To achieve this, standard techniques to locate objects in 3D space may be used. Examples include using two forward facing cameras to enable stereoscopic image location, or structured lights, or depth by defocus.

Since the transparent display is of relatively low information content with respect to the high definition display, there is very little overhead in calculating the extra display data required for the transparent display. This is very important in gaming applications where computational resources are in high demand for the high resolution rendering at high frame rates of the high definition display.

If the user rotates the head around the vertical axis but still looks at the high resolution display then the user will perceive additional vision in the direction of rotation beyond the standard±95° field of view that would be experienced if the user was looking directly at the centre of the high resolution display. This will give an additional feeling of immersiveness, since the peripheral vision will appear to continue to wrap-around as the head moves further around, even potentially past the point where the high resolution display is visible.

The use of an external physical high resolution display is not required. The high resolution area could be the natural environment, or another virtual environment produced using a head mounted display. For example, WO2011/124897A1 describes an embedded grating technology which uses a reflective structure, for example a Fresnel grating, coated and embedded within a media of the same refractive index either side of the coating. The optical structure does not deviate the light on transmission, but can provide optical power on reflection. In combination with appropriate projector optics, a virtual image can be displayed to the user and a distance beyond that of the structure itself, for example a comfortable viewing distance of several metres to infinity. One embodiment of the present invention provides the high resolution image using this embedded grating technology, and the surrounding out-of-focus immersive images using the embedded diffuser technology previously described.

In this way the two images are permanently locked together since they are formed in the same device. Therefore the user can always see a high resolution image as they move their head, and are not limited to a real display device located in the real environment. In this scenario, the high resolution scene is typically set at one focal length (unless high speed focus switching technologies are applied to provide multiple focal planes) and the immersive environment is defocused due to its close proximity to the eye.

Further to the above, the grating it may be advantageous in some circumstances to combine the embedded grating and diffuser technologies in the same viewable area to produce part of the image to be in focus at a far distance, and part of the image to be defocused since it is in the very near field to give the impression of two focus planes. This could be achieved by providing separate embedded layers for the grating and diffuser, preferably with the diffuser illuminated from a significantly different direction to the grating illumination and the diffusion properties designed such that only the light from the diffuser illumination is diffused into the appropriate eye. In this way, light that is diffused from the grating illuminator by the diffusing layer does not reach the user's eye, and the light that is reflected from the diffuser illuminator by the Fresnel grating layer does not reach the user's eye. Therefore the light and apparent images from the diffuser and Fresnel grating are kept functionally separate as far as the light reaching the eye is concerned, and the user sees both images at the correct focal length without optical cross talk between the two methods of image projection.

Similarly, one layer could be used, in which the Fresnel reflector is present, but with multiple small areas of the grating covered in the diffuser structure. In this way the structure is simpler to mass manufacture, and both optical functions are performed.

A method of achieving the same dual focus functions with an external display is to display the low resolution out of focus images in the otherwise ‘blank area’ such that both the out of focus and high definition images are simultaneously perceived by the user in the same space. It may be necessary to simulate occlusion of objects to improve the illusion of solid objects in front of (out of focus) backgrounds.

In another embodiment where the Fresnel reflector is used for high resolution images in the far field and the diffuser for out of the focus immersive display, software may be used to detect selected people or objects, and blank the appropriate areas in the diffuser display, thereby letting the user see the people or objects without obstructing. This enables augmented environments to be observed by the user with real people seen in the environment, rather than avatars. This may be useful for role playing games where users may be in an open space where they can see each other, however to each of them they are in a virtual reality space, but still see each other.

In a similar embodiment, multiple high definition displays could be observed by the user, and the low resolution diffuser display show the regions outside of the multiple displays, for example connecting regions as well has high angle viewing. As long as the viewer is not looking at the connecting regions the appearance would be of a very wide angle high resolution display environment.

In a similar embodiment, other people and objects could be made visible through the diffusing display by choosing an appropriate blank area. This would make it possible to see other user's face or body in the environment, or to see a keyboard, mouse or other device to drive the computer game, software, or similar device. The ability to clearly see a keyboard through the diffusing display is valuable in computer games where keyboard skills are needed, and occluding display technologies block the visual field of view for these important control systems. It is obvious that similar control systems may be important to be kept visible, for example is cars or aircraft.

In another embodiment, the user could wear glasses or contact lenses with a positive optical power in addition to the high definition and transparent displays, such that the transparent display is able to be viewed closer to or at the correct focal distance, and enable a sharper image to be obtained. The high definition display would need to be closer to the user to enable the user to focus on it. For example, an additional 2 Diopters of optical power would mean that the user would need to observe the high definition display at 0.5 m distance, and would perceive the focus to be at infinity. If the transparent display was at 15 cm distance from the user then it would normally be difficult to focus on the transparent display. If an additional 2D of optical power was available via spectacles or contact lenses then the approximate perceived focal distance of the transparent display would be approximately 21 cm, which is substantially easier to focus on. Additionally, the de-focus blurring of the near field images at an apparent 21 cm focal length will be less than the same image at an apparent 15 cm focal length, when viewing the high resolution display at infinity.

Possible application areas are:
1. Augmenting existing displays such as TVs, computer monitors, laptop screens, mobile phones for gaming applications, immersive TV and film.
2. Immersive viewing for aircraft entertainment systems, where a small high definition monitor at close distance can be augmented to produce a feeling of greater space.
3. Immersive viewing for cinemas, using existing film projection, with glasses to augment the view beyond the conventional screen area to produce an IMAX display effect, but without the need to modify the cinema. Could also be used to patch in part of the cinema screen if the view is obstructed by someone in front—this part would be out of focus, but would still probably be better than a blacked out area.
4. Shop window displays, where the transparent display is the window and the position of the user is tracked to provide the correct display image.
5. Immersive displays for MRI machines or other enclosing claustrophobic equipment, instruments and environments to give the user a sense of being embedded in an alternative environment so as to produce a feeling a reduced stress.
6. Extended field of view in restricted view vehicles such as trucks, agricultural machinery, planes, where additional cameras and image fusing can be used to provide the additional immersion information.
7. Immersive viewing where people, objects or additional displays in the real life can be seen through the low resolution display by providing additional blank areas. This is useful to avoid using avatars (to show the real faces of other people) and showing objects such as important control devices (e.g. keyboards).

1. An optical system comprising a transparent display arranged to be placed in a near field view of a viewer; and
image generation means for generating an image on the transparent display, the formed image having a blank area formed therein to allow the viewer to view an image of higher resolution than the first.

2. The system of claim 1, further comprising a second display arranged in a far field view of the viewer and configured to display a higher resolution image within the blank area.

3. The system of claim 1, wherein the transparent display and image generation means are configured as a headset to be worn by the viewer.

4. The system of claim 3, wherein the headset has motion sensors to track the position of the head and the position of at least one eye.

5. The system of claim 4, wherein the image generation means moves the position of the blank region within the transparent display dependent upon the outputs of the sensors.

6. The system of claim 3, wherein the transparent display comprises an embedded diffuser in combination with a projector to provide the generated image to form the transparent display.

7. The system of claim 6, wherein the projectors are arranged to project images either horizontally or vertically.

8. The system of claim 3, further comprising a further optical component having optical power to make the perceived focal distance of the transparent display further away than the physical location of the transparent display with respect to the viewer's eye.

9. The system of claim 1, wherein the image generation means feathers the edge of the blank so that there is not a sharp transition between the blank and the surrounding image.

10. The system of claim 2, wherein more than one blank is produced for each eye of the viewer to enable the viewer to view more than one image in a far field location whilst still viewing a near field image in the remainder of their field of view.

11. The system of claim 3, wherein more than one blank is produced for each eye of the viewer to enable the viewer to view more than one image in a far field location whilst still viewing a near image in the remainder of their field of view.
